(19) United States
(12) Patent Application Publication
(10) Pub. No.: US 2005/0225543 A1
(43) Pub. Date: Oct. 13, 2005

(54) Display circuit having asymmetrical nonlinear resistive elements

(75) Inventor: Willem den Boer, Hillsboro, OR (US)

Correspondence Address: KOLISCH HARTWELL, P.C., 520 S.W. YAMHILL STREET, SUITE 200, PORTLAND, OR, 97204, US

(73) Assignee: ScanVue Technologies LLC

(21) Appl. No.: 11/100,644

(22) Filed: Apr. 6, 2005

Related U.S. Application Data
(60) Provisional application No. 60/560,431, filed on Apr. 7, 2004.

(51) Int. Cl. G09G 5/00

(52) U.S. Cl. 345/204

(57) ABSTRACT

A display circuit. The display circuit includes a capacitor having a pixel node and a data node. The display circuit also includes a first select line and a first nonlinear resistive element operatively connecting the pixel node of the capacitor to the first select line, wherein the first nonlinear resistive element presents a different resistance if a negative polarity voltage is applied to the first nonlinear resistive element than if a positive polarity voltage is applied to the first nonlinear resistive element. The display circuit also includes a second select line and a second nonlinear resistive element operatively connecting the pixel node of the capacitor to the second select line, wherein the second nonlinear resistive element presents a different resistance if a negative polarity voltage is applied to the second nonlinear resistive element than if a positive polarity voltage is applied to the second nonlinear resistive element. The first nonlinear resistive element and the second nonlinear resistive element of the display circuit are orientated to present substantially equivalent resistances upon application of opposite polarity select pulses to the first and second select lines.

### CROSS-REFERENCES

This application claims the benefit of U.S. Provisional Application No. 60/560,431, filed Apr. 7, 2004, which is incorporated by reference.

### BACKGROUND

Many devices now include displays for presenting visual information. In general, a display has several attributes that affect its suitability for a particular purpose. Among these attributes are size, brightness, contrast, resolution, clarity, viewing angle, and energy consumption. In general, it is beneficial to manufacture high-resolution, energy-efficient, high contrast, wide viewing angle, bright displays. Furthermore, it is desirable to manufacture such displays at a low cost and with high reliability.

### BRIEF DESCRIPTION OF THE DRAWINGS

FIG. 1 schematically shows an exemplary dual select diode pixel.

FIGS. 2 and 3 schematically show current flow through an exemplary diode responsive to an applied voltage.

FIG. 4 plots the current-to-voltage characteristics of an exemplary asymmetrical diode.

FIGS. 5a and 5b schematically show asymmetrical current flow through an exemplary diode of FIG. 1.

FIG. 6 schematically shows a dual select diode pixel that includes diodes orientated in opposing directions.

FIG. 7 schematically shows a dual select diode pixel that includes diodes orientated in the same direction.

FIGS. 8 and 9 show exemplary methods for layering the diodes of FIG. 6.

FIGS. 10 and 11 show exemplary methods for layering the diodes of FIG. 7.

### DETAILED DESCRIPTION

Active matrix liquid crystal displays are widely used in a variety of applications, including notebook computers, flat panel monitors, handheld computers, cellular phones, and flat panel televisions. Active matrix liquid crystal displays may be fabricated by depositing and patterning various metals, insulators, semiconductors, and/or other materials on substrates. Such displays commonly employ semiconductor devices, such as amorphous silicon (a-Si) thin film transistors. Each pixel in the active matrix liquid crystal display may be coupled to an address transistor, which controls the voltage on each pixel and therefore its transmittance.

A growing application for active matrix liquid crystal displays is in large area televisions, which may have a diagonal size of up to 50 inches or more. However, thin film transistor controlled pixel arrays are difficult to manufacture for this application since a relatively large number of process steps are required to construct the thin film transistors. The total mask count may be 5 or 6 or more, which is burdensome. While the yields for small displays can be quite high, it is difficult to obtain an acceptable yield for large area displays. In addition, the design rules for patterning the various insulator, metal, and semiconductor layers are the same for small and large thin film transistor liquid crystal displays, requiring expensive photo-exposure equipment for large area substrates. This all increases the manufacturing expense of such thin film transistor liquid crystal displays.

Thin film diodes, including those referred to as metal-insulator-metal diodes, can be more economical to fabricate than a-Si thin film transistors. When a single thin film diode is used in series with a liquid crystal pixel, any variation in the thin film diode characteristic across the display area or over time or temperature can lead to a variation in the pixel voltage. This can result in poor gray scale control, poor uniformity, slow response time, and/or image sticking. In addition, it is difficult, if not impossible, to scale up single thin film diode liquid crystal displays to a diagonal size larger than about 10 inches without severe brightness gradients.

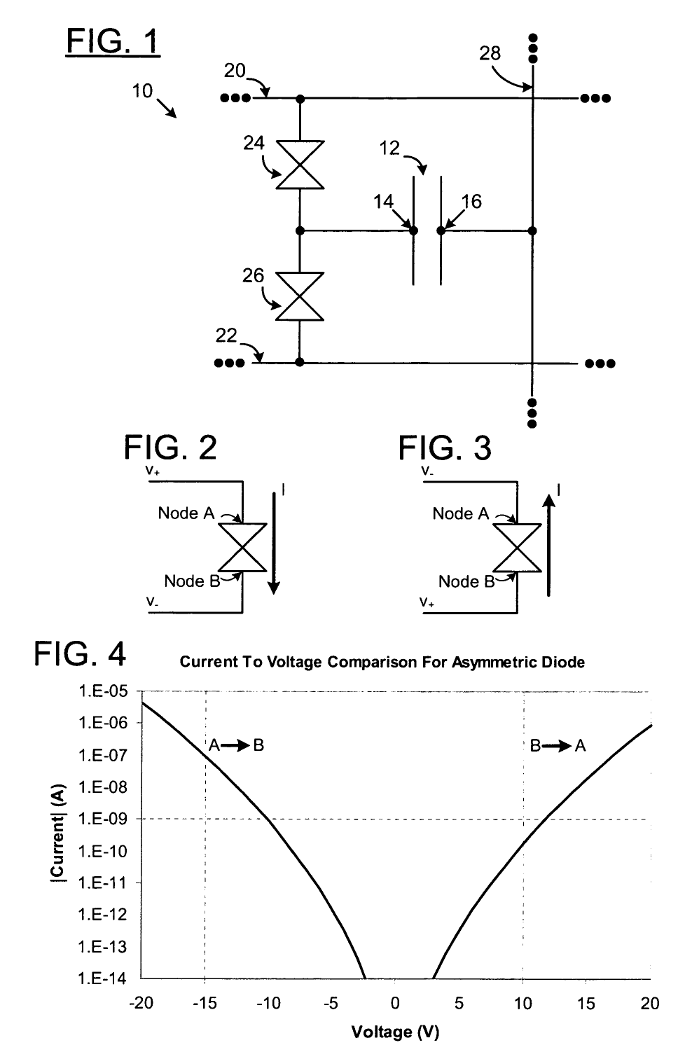

However, a differential circuit having two thin film diodes per pixel and two select lines for each row of pixels may mitigate, if not eliminate, the drawbacks of the single thin film diode approach. FIG. 1 shows an exemplary pixel 10 of a differential circuit that includes a capacitor 12 having a pixel node 14 and a data node 16. Capacitor 12 can be a constituent element of a light-producing module. The capacitor can be configured to control characteristics of light that is output via the light-producing module. Pixel 10 also includes a first dedicated select line 20 and a second dedicated select line 22. While the illustrated embodiment shows a differential circuit in which each row of pixels has two dedicated select lines, it should be understood that a differential circuit that utilizes shared select lines between adjacent rows of pixels is within the scope of this disclosure. A first thin film diode 24 operatively connects the first select line to the pixel node of the capacitor, and a second thin film diode 26 operatively connects the second select line to the pixel node of the capacitor. A data line 28 is operatively connected to the data node of the capacitor. The data line and the select lines can be cooperatively controlled to selectively charge the capacitor. U.S. Pat. Nos. 4,731,610, 6,222,596, 6,225,968, and 6,243,062 describe arrangements that utilize such differential circuits, and are hereby incorporated herein by reference. Displays utilizing a differential circuit similar to the one depicted in FIG. 1 are commonly referred to as dual select diode liquid crystal displays.

The fabrication of a dual select diode active matrix liquid crystal display is typically less difficult than that of thin film transistor arrays. In particular, dual select diode active matrix liquid crystal displays can be fabricated in fewer mask steps (typically only two or three), with relaxed design rules that scale with the display size. When operated in a dual select mode, the pixel circuit acts as an analog switch. The dual select diode circuit is not a two-terminal switching device, but rather a three-terminal switching device, like those that incorporate a thin film transistor. A dual select diode display offers performance similar to that of thin film transistor liquid crystal displays, with accurate gray shade control, fast response time, and tolerance for variations in thin film diode characteristics over time and across the viewing area. Such a dual select diode liquid crystal display is also relatively insensitive to propagation delays on the select and data lines and can therefore be scaled up to a very large area, for example, exceeding 40 in. in diagonal size.

As shown in FIGS. 2 and 3, the direction of current through a thin film diode can correspond to a voltage applied to the thin film diode. In the case of FIG. 2, a relatively higher voltage is applied to node A than to node B, thus driving current from node A to node B. Conversely, in FIG. 3, a relatively higher voltage is applied to node B than to node A, and current flows from node B to node A.

The dominant conduction mechanism in many thin film diodes, such as SiNₓ diodes, is Frenkel-Poole conduction. Frenkel-Poole conduction is largely a bulk effect dependent on the increase in free electrons caused by the effective lowering of trap level energy in a strong electric field. The equation for Frenkel-Poole current I is:

$$I = S . κ . V exp ( α \sqrt{\frac{V}{d}} )$$

Where S is the diode area, V is applied voltage, d is film thickness and

$$\frac{V}{d}$$

is the electric field. κ and α are constants that depend on the temperature and on the ratio of Si to N in the SiNₓ film (when SiNₓ is used to form the insulating layer in the diode). Ideally, Frenkel-Poole conduction is a bulk effect and the diode characteristics are symmetric, i.e. the current is the same for V+ and V−. In practice, some asymmetry in thin film diodes can be caused by the nature (e.g. the different work functions) of the contact metal or transparent conductor. The work function determines the barrier for electron injection from the contacts. Also, the film stoichiometry and interface at the bottom contact and the top contact can be different, further contributing to the asymmetry.

Some thin film diodes, such as metal-insulator-metal diodes can have appreciable residual asymmetry. In other words, a current to voltage relationship will not be the same in both directions across the diode. FIG. 4 plots current relative to voltage (V_{B}-V_{A}) in an exemplary asymmetric diode. As can be seen, current flow is greater in the direction from node A to node B than it is in the direction from node B to node A.

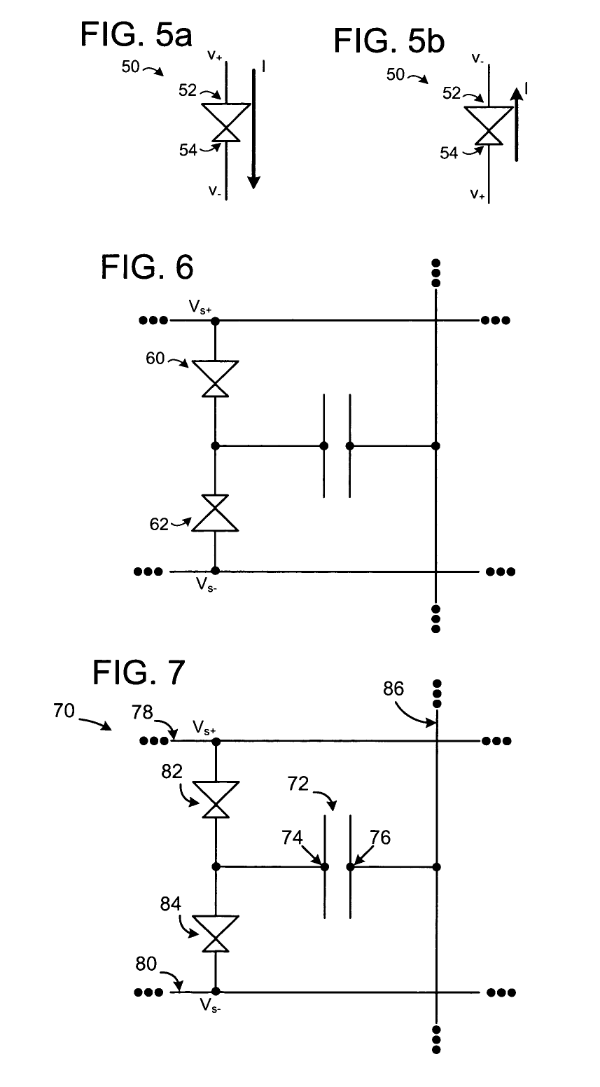

A thin film diode or bi-directional thin film diode, as used herein, is a nonlimiting example of a nonlinear resistive element. FIGS. 5a and 5b schematically show an exemplary nonlinear resistive element 50. Nonlinear resistive element 50 includes a first node 52 and a second node 54. In FIG. 5a, a positive voltage is applied to node 52. In FIG. 5b, a negative voltage is applied to node 52. As can be seen by comparison, the resulting current has a greater magnitude in FIG. 5a than in FIG. 5b. This is because nonlinear resistive element 50 presents less resistance when a positive polarity voltage is applied to the nonlinear resistive element (FIG. 5a) than when a negative polarity voltage (FIG. 5b) is applied to the nonlinear resistive element. In other words, nonlinear resistive element 50 is asymmetrical.

FIG. 6 shows a pixel in which asymmetric nonlinear resistive elements 60 and 62 are orientated in opposing directions. Once the liquid crystal pixel capacitor has been charged, the same current will flow through both diodes. However, because of the diode asymmetry and the opposing orientation of the diodes, the voltage drop across each diode will not be equal. When select pulses are set so that |Vₛ₊| equals |V_{S-}| and data pulses are +V_{d} or −V_{d}, a nonzero DC voltage will be present across the liquid crystal capacitor. The asymmetry can create a DC component larger than about 50 mV across the liquid crystal capacitor in some circumstances. The liquid crystal capacitor operates with an AC voltage and any DC component is preferably less than about 50 mV.

In one embodiment, diode asymmetry can be compensated for and an undesired DC component can be cancelled by utilizing a drive scheme in which the data voltage and/or select voltages are offset. Such an approach can be difficult to effectively implement unless the diode asymmetry is small and uniform across the display area.

FIG. 7 schematically shows a pixel that is configured to compensate for asymmetry in the nonlinear resistive elements. In particular, FIG. 7 shows a pixel 70 that includes a capacitor 72 having a pixel node 74 and a data node 76, and a pair of select lines 78 and 80 that are operatively connected to the pixel node of the capacitor by asymmetrical nonlinear resistive elements 82 and 84. The nonlinear resistive elements are orientated in the same direction. A data line 86 is operatively connected to the data node of the capacitor.

Nonlinear resistive elements can be orientated to present substantially equivalent resistances upon application of opposite polarity select pulses to the select lines. A pixel in which the nonlinear resistive elements are orientated in the same direction may effectively compensate for asymmetry regardless of the magnitude of asymmetry in the nonlinear resistive elements, or the variation in asymmetry across the display area. By orientating the nonlinear resistive elements in the same direction, the voltage drop will be approximately the same across each nonlinear resistive element, and an unacceptable DC component across the liquid crystal capacitor can be avoided. In such an arrangement, both nonlinear resistive elements will have approximately the same current-to-voltage characteristics because asymmetry has been compensated for by arranging the nonlinear resistive elements in the same direction. The voltage at the pixel node should settle to (Vₛ₊+Vₛ₋)/2 regardless of the degree of asymmetry or its long range variation across the display area. Therefore, if Vₛ₊=−Vₛ₋, the voltage at the pixel node should settle to zero during the select time. The asymmetry can vary from pixel to pixel without creating a DC component across the liquid crystal when two nonlinear resistive elements within one pixel have substantially similar current-voltage characteristics.

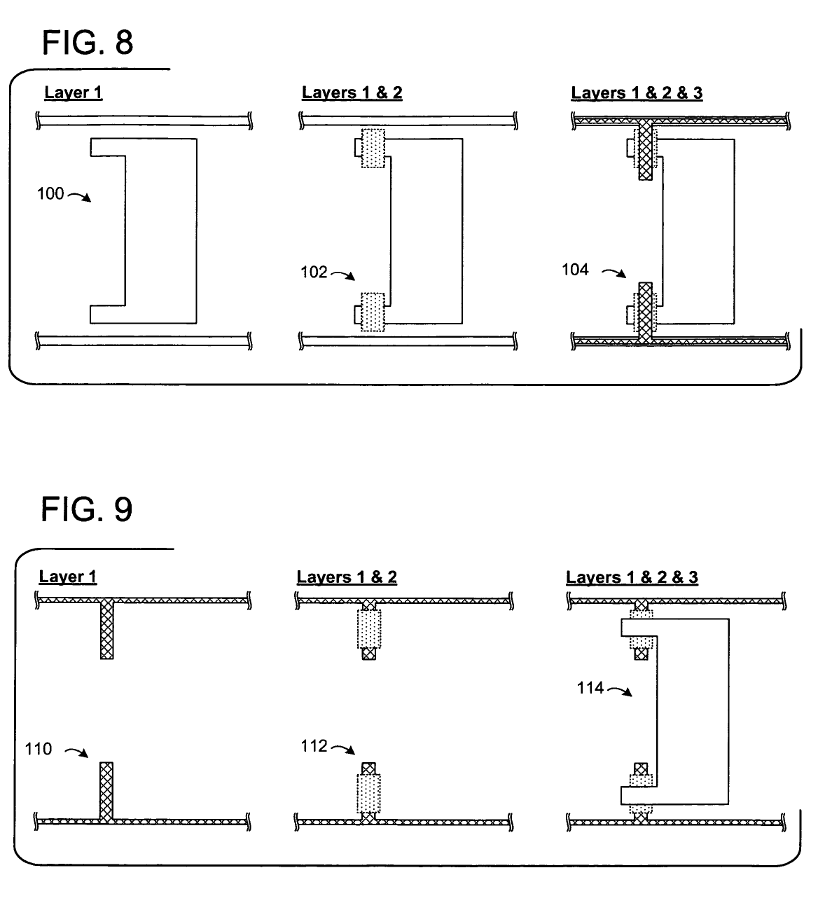

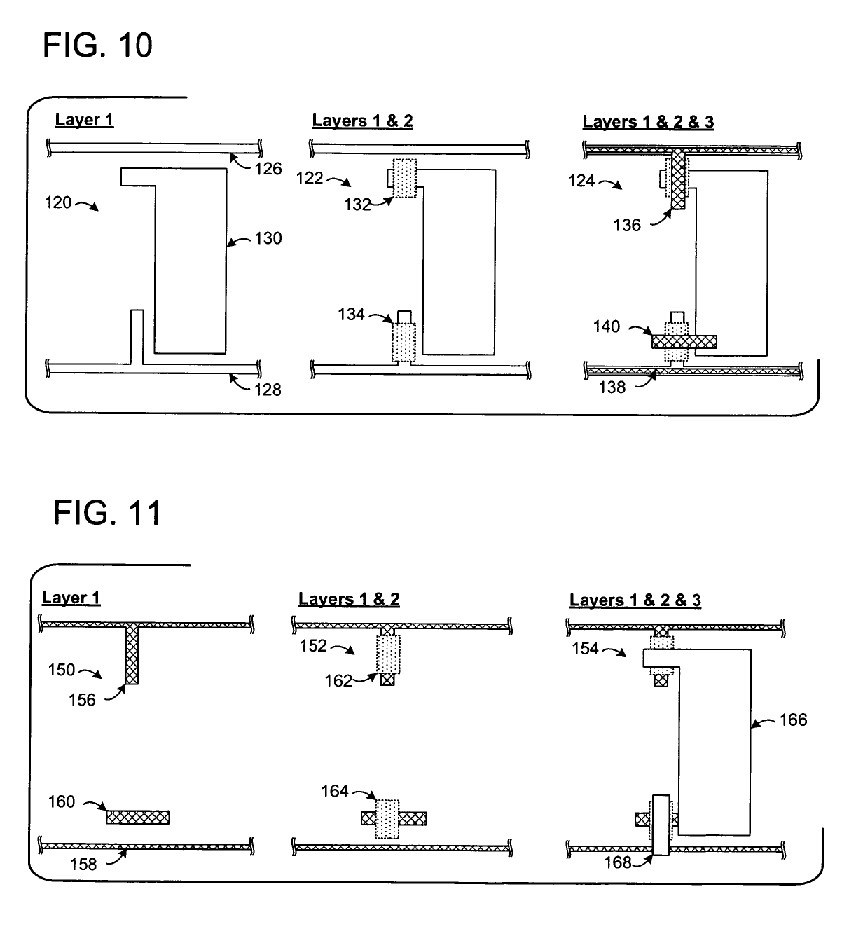

FIGS. 8-11 somewhat schematically show exemplary methods for forming a portion of a display pixel that incorporates asymmetrical nonlinear resistive elements in the form of thin film diodes. FIGS. 8 and 9 show different methods for arranging the diodes in opposing directions. Such arrangements correspond to the circuit illustrated in FIG. 6. FIGS. 10 and 11 show different methods for arranging the diodes in the same direction. Such arrangements correspond to the circuit illustrated in FIG. 7. As can be seen, each of the illustrated diode arrangements can be formed in three layers. It should be understood that FIGS. 8-11 represent exemplary methods, and that diodes, and/or circuits incorporating such diodes, can be formed via other methods without departing from the scope of this disclosure.

FIG. 8 shows a three layer process in which a transparent-conductor layer 100 is formed before an insulating layer 102 is formed and the insulating layer is formed before a conducting layer 104 is formed. FIG. 9 shows a three layer process in which a conducting layer 110 is formed before an insulating layer 112 is formed and the insulating layer is formed before a transparent-conductor layer 114 is formed.

FIG. 10 shows a three layer process in which a transparent-conductor layer 120 is formed before an insulating layer 122 is formed and the insulating layer is formed before a conducting layer 124 is formed. The transparent-conductor layer can include a first select-line base 126, a second select-line base 128, and a pixel electrode 130. The insulating layer can include a first insulating portion 132 operatively connected to the pixel electrode and a second insulating portion 134 operatively connected to the second select-line base. The conducting layer can include a first select line 136 operatively connected to the first select-line base and the first insulating portion, a second select line 138 operatively connected to the second select-line base, and a bridge section 140 operatively connected to the second insulating portion and the pixel electrode.

FIG. 11 shows a three layer process in which a conducting layer 150 is formed before an insulating layer 152 is formed and the insulating layer is formed before a transparent-conductor layer 154 is formed. The conducting layer can include a first select line 156, a second select line 158, and a conducting bridge section 160. The insulating layer can include a first insulating portion 162 operatively connected to the first select line and a second insulating portion 164 operatively connected to the conducting bridge section. The transparent-conductor layer can include a pixel electrode 166 operatively connected to the first insulating portion and the conducting bridge section and a transparent-conductor section 168 operatively connected to the second insulating portion and the second select line.

A transparent conductor layer may include indium-tin-oxide (ITO) or another suitable material. An insulating layer may include a silicon nitride (SiNx) or another suitable material. A conducting layer may include a metal, such as aluminum, copper, tin, etc., or another suitable conductor. It should be understood that the disclosed materials are provided for exemplary purposes, and that other materials may be used while remaining within the scope of this disclosure.

FIGS. 8 and 10 show embodiments in which the select busline is formed with both a transparent-conducting layer and a conducting layer. This is, however, not necessary. In some embodiments, the busline may include only metal or another material that is sufficiently conductive. For example, FIGS. 9 and 11 show embodiments in which the busline does not include a redundant transparent-conducting layer.

Although the present disclosure has been provided with reference to the foregoing operational principles and embodiments, it will be apparent to those skilled in the art that various changes in form and detail may be made without departing from the spirit and scope defined in the appended claims. The present disclosure is intended to embrace all such alternatives, modifications and variances. Where the disclosure or claims recite “a,” “a first,” or “another” element, or the equivalent thereof, they should be interpreted to include one or more such elements, neither requiring nor excluding two or more such elements.

1. A pixel circuit, comprising:
a capacitor having a pixel node and a data node;
a first select line;
a first nonlinear resistive element operatively connecting the pixel node of the capacitor to the first select line, wherein the first nonlinear resistive element presents a different resistance if a negative polarity voltage is applied to the first nonlinear resistive element than if a positive polarity voltage is applied to the first nonlinear resistive element;
a second select line; and
a second nonlinear resistive element operatively connecting the pixel node of the capacitor to the second select line, wherein the second nonlinear resistive element presents a different resistance if a negative polarity voltage is applied to the second nonlinear resistive element than if a positive polarity voltage is applied to the second nonlinear resistive element;
wherein the first nonlinear resistive element and the second nonlinear resistive element are orientated to present substantially equivalent resistances upon application of opposite polarity select pulses to the first and second select lines.

2. The pixel circuit of claim 1, wherein the first and second nonlinear resistive elements each include an asymmetrical diode.

3. The pixel circuit of claim 1, wherein the first and second nonlinear resistive elements each include an insulating layer formed on top of a conducting layer and a transparent-conductor layer formed on top of the insulating layer.

4. The pixel circuit of claim 1, wherein the first and second nonlinear resistive elements each include an insulating layer formed on top of a transparent-conductor layer and a conducting layer formed on top of the insulating layer.

5. The pixel circuit of claim 1, wherein the capacitor is a constituent element of a light-producing module, and wherein the capacitor is configured to control characteristics of light output via the light-producing module.

6. The pixel circuit of claim 5, wherein the light-producing module includes an exit polarizer configured to modulate light output responsive to a relative charge of the capacitor.

7. The pixel circuit of claim 1, wherein the first nonlinear restive element and the second nonlinear resistive element are orientated to present substantially equivalent resistances upon application of substantially equivalent magnitude and opposite polarity select pulses to the first and second select lines.

8. A pixel circuit, comprising:
a capacitor having a pixel node and a data node;
a first select line;
a first nonlinear resistive element operatively connecting the pixel node of the capacitor to the first select line, wherein the first nonlinear resistive element presents a different resistance if a negative polarity voltage is applied to the first nonlinear resistive element than if a positive polarity voltage is applied to the first nonlinear resistive element;
a second select line; and
a second nonlinear resistive element operatively connecting the pixel node of the capacitor to the second select line, wherein the second nonlinear resistive element presents a different resistance if a negative polarity voltage is applied to the second nonlinear resistive element than if a positive polarity voltage is applied to the second nonlinear resistive element;
wherein the first nonlinear restive element and the second nonlinear resistive element are orientated in the same direction.

9. A display comprising:
a matrix of pixels arranged in a plurality of pixel rows and pixel columns;
for each pixel row, a pair of select lines configured to selectively allow video data to be loaded to pixels of that pixel row; and
for each pixel column, a data line configured to selectively load video data to pixels of that pixel column;
wherein each pixel of the matrix includes a capacitor having a pixel node and a data node, wherein the pixel node is operatively connected to a first select line of the pair of select lines via a first nonlinear resistive element and to a second select line of the pair of select lines via a second nonlinear resistive element; and
wherein the first nonlinear resistive element and the second nonlinear resistive element are orientated in the same direction.

10. A display comprising:
a matrix of pixels arranged in a plurality of pixel rows and pixel columns;
for each pixel row, a pair of select lines configured to selectively allow video data to be loaded to pixels of that pixel row; and
for each pixel column, a data line configured to selectively load video data to pixels of that pixel column;
wherein each pixel of the matrix includes a capacitor having a pixel node and a data node, wherein the pixel node is operatively connected to a first select line of the pair of select lines via a first asymmetrical nonlinear resistive element and to a second select line of the pair of select lines via a second asymmetrical nonlinear resistive element; and
wherein the first asymmetrical nonlinear restive element and the second asymmetrical nonlinear resistive element are orientated to present substantially equivalent resistances upon application of opposite polarity select pulses to the first and second select lines.

11. The display of claim 10, wherein the first and second asymmetrical nonlinear resistive elements each include an asymmetrical diode.

12. The display of claim 10, wherein the first and second asymmetrical nonlinear resistive elements each include an insulating layer formed on top of a conducting layer and a transparent-conductor layer formed on top of the insulating layer.

13. The display of claim 10, wherein the first and second asymmetrical nonlinear resistive elements each include an insulating layer formed on top of a transparent-conductor layer and a conducting layer formed on top of the insulating layer.

14. The display of claim 10, wherein the capacitor is a constituent element of a light-producing module, and wherein the capacitor is configured to control characteristics of light output via the light-producing module.

15. The display of claim 14, wherein the light-producing module includes an exit polarizer configured to modulate light output responsive to a relative charge of the capacitor.

16. A method of fabricating a dual select diode display circuit, comprising:
depositing a conducting layer, an insulating layer, and a transparent-conductor layer to form first and second thin film diodes that are orientated in the same direction and are each operatively connected to a common pixel node.

17. The method of claim 16, wherein the insulating layer includes silicon nitride.

18. The method of claim 16, wherein the transparent-conductor layer includes indium-tin-oxide.

19. The method of claim 16, wherein the first and second thin film diodes are each orientated in the same direction by arranging the insulating layer on top of the transparent-conductor layer and arranging the conducting layer on top of the insulating layer.

20. The method of claim 16, wherein the first and second thin film diodes are each orientated in the same direction by arranging the insulating layer on top of the conducting layer and arranging the transparent-conductor layer on top of the insulating layer.

21. A method of fabricating a dual select diode display circuit, comprising:
forming a transparent-conductor layer that includes a first select-line base, a second select-line base, and a pixel electrode;
forming an insulating layer that includes a first insulating portion operatively connected to the pixel electrode and a second insulating portion operatively connected to the second select-line base; and
forming a conducting layer that includes a first select line operatively connected to the first select-line base and the first insulating portion, a second select line operatively connected to the second select-line base, and a bridge section operatively connected to the second insulating portion and the pixel electrode.

22. The method of claim 21, wherein the insulating layer includes silicon nitride.

23. The method of claim 21, wherein the transparent-conductor layer includes indium-tin-oxide.

24. The method of claim 21, wherein the transparent-conductor layer is formed before the insulating layer is formed and the insulating layer is formed before the conducting layer is formed.

25. The method of claim 21, wherein the conducting layer is formed before the insulating layer is formed and the insulating layer is formed before the transparent-conductor layer is formed.

26. A method of fabricating a thin film diode display circuit, comprising:
forming a conducting layer that includes a first select line, a second select line, and a conducting bridge section that is separated from the second select line;
forming an insulating layer that includes a first insulating portion operatively connected to the first select line and a second insulating portion operatively connected to the conducting bridge section; and
forming a transparent-conductor layer that includes a pixel electrode operatively connected to the first insulating portion and the conducting bridge section and a transparent-conductor section operatively connected to the second insulating portion and the second select line.

27. The method of claim 26, wherein the insulating layer includes silicon nitride.

28. The method of claim 26, wherein the transparent-conductor layer includes indium-tin-oxide.
